(19) United States
(12) Patent Application Publication
(10) Pub. No.: US 2007/0174289 A1
(43) Pub. Date: Jul. 26, 2007

(54) Management of non-traditional content repositories

(76) Inventor: Tom Utiger, Las Vegas, NV (US)

Correspondence Address: DECHERT LLP, P.O. BOX 10004, PALO ALTO, CA, 94303, US

(21) Appl. No.: 11/334,112

(22) Filed: Jan. 17, 2006

(51) Int. Cl. G06F 17/30

(52) U.S. Cl. 707/10

(57) ABSTRACT

A method for managing a client device is described. The method includes: (1) initiating a search query in a management tool; (2) conveying the search query from the management device to the client device, which includes a non-traditional content repository; (3) implementing said search query on said non-traditional content repository in said client device; and (4) sending result of said search query from said client device to said management tool.

### FIELD OF THE INVENTION

The present invention relates generally to records and document management. More specifically, the present invention relates to systems and methods for managing non-traditional content repositories.

### BACKGROUND OF THE INVENTION

Records management has been practiced since humans first began transacting business. For example, in certain ancient cultures, clay tablets were used to document transactions involving land and livestock. Sometimes the tablets were wrapped in an envelope of baked clay, and then stored in a local temple. In the event of a dispute, a neutral third party (e.g., a priest or priestess) could break the authenticating envelope and verify the original transaction. These ancient practices demonstrate the importance of managing records properly so that they can be accessed and authenticated in the event of a legal dispute. Of course, the management of records has become far more complex in the modem world. First of all, records are no longer limited to tangible form such as paper, but now include many different forms of electronic data. Second, business transactions in the modem worlds are very complex and often involve hundreds of people working on a single transaction. In addition, the modem legal system demands that records be managed according to very particular policies governed by various regulatory agencies. As a result of these increasingly complex demands, records management is now an incredibly difficult challenge for even the largest and most sophisticated corporations.

Records management was a staid but well developed practice until the relatively recent proliferation of electronic systems and electronic documents. Records managers have struggled over the past few decades to manage more and more different types of electronic records in an increasingly wide variety of different business contexts. Just like a paper record, electronic records must be managed in a way that protects the integrity and authenticity of the record. Currently, there is a wide gap between the legal requirements for record authenticity and technological advances in the computer industry. Unfortunately, the development of computer systems and electronic records has outpaced the development of records management systems.

Records management systems developed over past few decades generally fall into one of four distinct generations. Each generation provides solutions to different problems, but leaves a variety of other problems unsolved. First generation records management software systems were developed in the 1970s to manage physical assets such as inventory, boxes, folders, files and microfilm. These types of systems, which still to some extent, allow companies to track and identify records that need to be dispositioned. While the early versions of the first generation systems were simple and unsophisticated databases, modem versions have become highly specialized and provide a wider set of features for managing physical records. However, these systems do not interact with electronic document repositories. Recent regulatory changes changed the focus of records management from physical records to electronic records.

Second generation records management systems, first introduced in the 1980's, allow for management of specialized content repositories of electronic records. Many features have been added to these products since their first introduction, and they remain prevalent in today's market. But, there are a number of problems with these second generation systems. The first and foremost is that they are only operative to manage records in a single content repository. Using such systems, the only records under control are those that have been placed into the single content repository. Companies using second generation records management systems therefore have many different systems managing different content repositories which do not integrate. Another problem with the second generation systems is that the records management content repositories are not optimized for general purpose document management. Instead, they are customized for accomplishing very particular records management processes. So in order to manage a document using a second generation system, the document must be moved out of the business production business process into the records repository. Copy control problems arise where a document is copied from one content repository to another, leading to the existence of multiple copies. Copy control problems of this nature can spiral out of control in large organizations that manage millions of documents. Most large organizations use many different electronic applications that generate and store electronic documents, including email systems, websites, file servers, document management systems, records management systems, accounting systems, and enterprise resource planning systems. Often, documents are moved and copied between these systems without regard to how many copies should exist and where they should be stored. As organizations grow, they invariably acquire more different types of systems generating more and more different types of documents, leading to greater problems.

Another problem with second generation systems is that lifecycle management functions are very limited. The term “lifecycle management” refers generally to policies, processes, practices, or tools used to manage records up to the time that the records are finally dispositioned. Lifecycle management has become particularly important following public concerns about corporate ethics that have led to government regulations (e.g., the Sarbanes-Oxley act) dictating that certain types of corporate records be managed according to various rules. Many corporations are currently struggling with the challenge of instituting policies for retaining and disposing of records in a manner that is in compliance with government regulations. Also, corporations are often faced with the problem of having to produce documents in response to court orders in the context of legal disputes. Ideally, the lifecycle management of a record would begin when the document is created or received. Using second generation systems, a document generally cannot be placed under lifecycle control until after all business processing has been completed. The execution of litigation holds and other lifecycle events often cannot wait until the end of business processing and official declaration of a document as a record. This has created great strife in organizations as they have interacted with the courts and regulators.

Third generation records management systems, first introduced in the late 1990s, provide for management of vendor aligned content repositories (i.e., content repositories configured and manufactured in accordance with specifications of particular vendors). These systems were developed to address customer demands for a single common records management point of control. Early versions of the third generation systems used a vendor aligned content repository method. In accordance with this method, a vendor provides a single records management tool that controls all of that vendor's products. This was a radical step forward in that you could now apply a uniform records management policy set to more than a single electronic document system. However, third generation systems inherited all of the failings of the previous generations where an organization uses products provided by different vendors.

The most glaring problem associated with third generation systems is that most organizations own document content repositories provided by multiple vendors. This leads to customers having to reorganize and consolidate a variety of internal systems. Such reorganization is very expensive in terms of time and lost profits. Thus, third generation vendor aligned systems do not provide an adequate solution to the problems associated with using multiple records management systems. For all but the smallest company there is still the problem that an organization must have more than one records management system to address the various content repositories or risk leaving them unmanaged.

Fourth generation records management systems, which were introduced in the early 2000s, utilize information lifecycle management (“ILM”) engines in taking a vendor neutral approach to management of document content repositories. One example of a fourth generation records management system is the DB2 Records Manager commercially available from IBM Corporation. In general, fourth generation systems are not limited to managing a specific content repository. Instead, they utilize software connectors to access and manage different types of content repositories. Fourth generation systems apply records controls functions and policies across different types of content repositories by communicating via these software connectors. Fourth generation systems also offer the ability to track the movement of document between content repositories as the documents moves through a business process. However, there are still a number of limitations associated with these systems. The first problem is that of tracking only declared records, and have no provision for tracking non-records that are contained in non-content repositories. In fourth generation systems, only those documents registered with the ILM engine are managed, while all of the other objects within an organization are effectively invisible. During litigation, when a corporation receives a request to produce certain documents, problems arise when the responsive documents have not been declared to be records. It is relatively easy to identify records that are already registered, but those, that are not registered, are difficult to find. Another related problem is that fourth generation systems cannot search across both records and non-records. Without a common search interface operative to search all types of content repositories and both records and non-records, which refer to content that is not declared to be a record or is not registered, there will be gaps in how records are processed in the organization.

With regard to drawbacks, previous generations of records management have focused on primarily managing content repositories that are deemed traditional by those skilled in the art and have virtually ignored managing non-traditional content repositories. Although organizations may attempt to apply records management to non-traditional content repositories, they are unable to control and manage such repositories in a meaningful manner. In its current limited application of records management to non-traditional content repositories, such application suffers from several drawbacks. For example, the current application is not automated and requires extensive human intervention. In other words, at various steps of records management human beings must carry out certain labor intensive tasks—e.g., manually extract documents out of non-traditional content repositories and manually image user hard drives. As another example, instead of creating a control mechanism or infrastructure which would allow for the management of non-traditional content repositories, another management approach has been to circumvent the lack of control problem by preventing the user's from using their desktops as a storage device for storing any content. As a result, this approach has at a minimum hampered user productivity and effectiveness. Moreover, certain software programs, which require access to and use of desktop, cannot be used as intended.

Even under those rare circumstances where records management is manually applied to the non-traditional content repositories, there is no method of addressing the myriads of other locations where content is hiding within a corporation. Using current methods and techniques, it is extremely time consuming, for example, during document discovery in a lawsuit, and often fruitless to try to track down the various copies of content.

None of the prior art records management systems include the necessary provisions to automatically control or manage non-traditional content repositories. By way of example, these non-traditional content repositories include instant messaging, websites, enterprise resource planning, email, email archives, filesystems, and relational databases. Previous generations of records management systems have primarily focused on managing objects that have been placed in a traditional content repository which are “easy” to manage, rather than deal with the vagaries of real world records management where records or documents generated by a user on a client device, such as a laptop, a palm display device, file servers, desktop computers, cell phones, voicemail systems and the like, are not capable of being centrally controlled and are not capable of being controlled using a uniform policy. In other words, the above-mentioned client devices, in their current state, are also incapable of being controlled and managed by the current records management systems.

What is, therefore, needed are systems and methods for records management which can automatically manage and control non-traditional content repositories.

### BRIEF SUMMARY OF THE INVENTION

Unlike the fourth generation records management systems, the present invention provides a common-interface that is capable of searching content, regardless of whether it is record or non-record. In the fourth generation systems, the search mechanism can access only those records that are registered with the information lifecycle management (“ILM”) engines, while completely ignoring non-records, which includes content that is not registered with the ILM engines. Specifically, the inventive search modules residing either on a management tool or a client device, circumvent the need for ILM interaction, and are able to facilitate searching of or taking action on any content, whether it is record or non-record. In those embodiments where an ILM is used, the search modules of the present invention, either alone or in conjunction with other modules, are capable of facilitating registeration of non-records. As a result, different types of modules employed according to the present invention facilitate tracking different types of content, which includes content contained in a non-traditional content repositories.

In one aspect, the present invention provides a method for managing a client device. The method includes: (1) initiating a search query in a management tool; (2) conveying the search query from the management device to the client device, which includes a non-traditional content repository; (3) implementing the search query on the non-traditional content repository in the client device; and (4) sending result of the search query from the client device to the management tool.

In another aspect, the present invention provides another method of managing a client device. The method includes: (1) initiating a search query in a management tool; (2) conveying the search query from the management tool to the client device, which includes a non-traditional content repository; (3) implementing the search query on the non-traditional content repository in the client device to produce result on the client device; and (4) taking action on the client device.

In yet another aspect, the present invention provides a system management tool. The system management tool includes a search management module which is capable of initiating a search query and is designed to be communicatively coupled with a client device such that when the search management module is communicatively coupled to the client device, the search query initiated at the search management module is communicated to the client device to search a non-traditional content repository.

In yet another aspect, the present invention provides a system management tool. The system management tool includes an action management module that is capable of initiating an action command and is designed to be communicatively coupled with a client device, such that when the action management module is communicatively coupled to the client device, the action command initiated at the action management module is communicated from the action management module to the client device and implemented upon a non-traditional content repository.

In yet another aspect, the present invention provides a client device. The client device includes a search implementation module capable of implementing on the client device a search query that is generated by a system management tool and wherein after implementing the search query, the search implementation module is configured to obtain a result from a non-traditional content repository on the client device.

### BRIEF DESCRIPTION OF THE DRAWINGS

These and other features, aspects and advantages of the present invention will become better understood with regard to the following description, appended claims, and accompanying drawings where:

FIG. 1 shows one embodiment of an inventive system management tool which includes a system management module communicatively coupled with a system implementation module located on one embodiment of an inventive client device;

FIGS. 2 shows another embodiment of an inventive system management tool which includes a system management module communicatively coupled with a system implementation module located on one embodiment of an inventive client device that also includes a local action module for taking action on the client device;

FIG. 3 shows a yet another embodiment of an inventive system management tool, which includes a system management module communicatively coupled with a system implementation module located on one embodiment of an inventive client device that also includes a local action module, which is in turn communicatively coupled to an action management module on the system management tool;

FIG. 4 shows a yet another embodiment of an inventive system management tool, which includes a system management module communicatively coupled with a system implementation module located on one embodiment of an inventive client device that also includes a local action module, which is also communicatively coupled to a system management module;

FIG. 5A shows a yet another embodiment of an inventive system management tool, which includes a system management module communicatively coupled with a system implementation module located on one embodiment of an inventive client device that also includes a local action module, which is in turn connected to an action management module on the system management tool and the system management module and the action management module are communicatively coupled to each other;

FIG. 5B shows a yet another embodiment of an inventive system management tool, which includes a system management module communicatively coupled with a system implementation module located on one embodiment of an inventive client device and also communicatively coupled to an action management module located on the system management tool;

FIG. 5C shows a yet another embodiment of an inventive system management tool, which includes a system management module communicatively coupled with a system implementation module located on one embodiment of an inventive client device that is also communicatively coupled an action management module on the system management tool;

FIG. 5D shows another embodiment of an inventive system management tool managing two separate client devices such that in response to an input from a first client device to the system management tool, the system management tool instructs a second client device;

FIG. 6A shows a yet another embodiment of an inventive system management tool, which includes an action management tool that instructs a local action module located on a client device; and

FIG. 6B shows a yet another embodiment of an inventive of an inventive system management tool, which includes an action management module that is communicatively coupled to a local action management module located on a client device and coupled such that instruction can be conveyed back and forth between the action management module and the local action management module.

### DETAILED DESCRIPTION OF THE INVENTION

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides an inventive system management tool, which is configured to be communicatively coupled to, among other things, a client device that includes a non-traditional content repository, e.g., filesystems, instant messaging, websites, enterprise resource planning, email, email archives and relational databases. In such configuration of the system management tool, it can manage, e.g., search or take action on, a non-traditional content repository located on the client device. The client device of the present invention is in turn configured to receive information and/or commands from a system management tool and implements the information and/or commands over one or more non-traditional content repositories contained therein. By way of example, a client device of the present invention includes a laptop, a palm display device, file servers, desktop computers, cell phones, voicemail systems and the like. Conventionally employed system management tools and non-traditional content repositories are not so configured.

Certain preferred embodiments of the system management tool include a search management module that is capable of initiating a search query. According to the present invention, the search query may be any type of search, e.g., search by words, search by metadata, search by key words, search by phrases, search with natural language, search by topics, search with wildcards, search by binary sequence, search by file characteristics (including filename, file size, author, create date, last modified date and file location), search by digital signature, search by linguistic pattern, search by controlled vocabulary, search by regular expression, search for approximations, or any combination of the above searches. The system management tool in such embodiments is designed to be communicatively coupled to a client device, which includes a non-traditional content repository, such that the initiated search query is communicated to the client device. In other preferred embodiments, the system management tool includes an action management module that is designed for taking action, such as sending electronic communications, such as email, instant messages, or pages, downloading information from the client device; uploading/storing documents/information in a content repository, registering documents as a record with a records management repository, placing documents on a “legal hold,” initiating another query, output documents to a location like CD-ROM/DVD or message queue, filtering, deduplication and instructing a location action module located on the client device or another different, client device.

In some embodiments of the present invention, the action management module is configured to take such actions after receiving an input from the client device. In other embodiments, on the management tool, the system management module and the action management module are communicatively coupled such that the action management module is configured to receive an input from the search management module and based on the input takes action. In such embodiments, it is also possible that the action management module takes management action and then provides an input to at least one client device for taking local action. By way of example, a system to detect and manage improper documents on the laptops/desktops of registered brokers at a brokerage house would initiate a query at a search management module (on a system management tool) that would send a query to the registered broker's machine (which is a client device in this example). A search implementation module located on the registered broker's machine, in turn, would implement a search for a responsive set of documents and send notice to the local action module, for example, to quarantine the files. Once quarantined, the search management module is apprised of this development through the search implementation module and the search management module sends the appropriate notice to the action management module, which then sends an email to the registered broker apprising him of the quarantined files.

On the client device side, a search implementation module is used to implement the initiated search query that is received from a search management module that is located on the system management tool. In certain embodiments of the client device, the search implementation module is configured such that after implementing the search query on a non-traditional content repository on the client device, it reports back the results it has obtained to the system management tool. Instead of reporting back the results to a local action module, the search results are reported to the search management module in particular, for processing, such as deduplication or filtering. Conventional search modules which operate on a laptop, for example, are not configured to communicate with a management search module located on a management tool, which manages one or more client devices that include non-traditional content repositories.

The client device may also include a local action module for, among other things, taking action on the client device. By way of example, based on search results from the search implementation module, the local action module may include sending a notification to a user, lock access to the client device, move a file, copy a file, transform a file format, download a code module, execute or initiate a custom search module, deduplicate files, expunge files, quarantine files, initiate a process, pause a process, stop a process, modify a file, encrypt a file, decrypt a file, compress a file, decompress a file, audit activity of a file, upload a file, download a file, create digital signature of a file, change file permissions, update user information, interact with an external service, and destroy files. In those embodiments where a local action module is employed, it is possible that the local action module and search implementation module are communicatively coupled, such that at least one specific of the above described actions are taken after the local action module receives a certain input from the search implementation module. By way of example, the local action module may receive an input from the search implementation module regarding files containing words/phrases that are deemed offensive and in response may delete the file from the filesystem of the client device.

In other embodiments of the client device according to the present invention, the local action module takes local action and reports back to the search management module. By way of example, the local action module purges all temporary files for a particular client device and then reports back to the search management module, which sends an email to owner of the client device apprising the owner that certain temporary files have been purged. When a plurality of client devices are under management of a single system management tool, it is also possible that a local action module on one client device acts based upon input provided to the system management tool from a second client device.

Various examples and the numerous embodiments described herein illustrate, among other things, that the search modules and/or action modules of the present invention are capable of operating on non-traditional content repositories as well as traditional content repositories. Furthermore, that these search modules and/or action modules allow for centralized action or management action on non-traditional content repositories as well as traditional content repositories. Those skilled in the art will recognize that it is impossible for previous generation records management systems to take such centralized action or management action on non-traditional content repositories. The fourth generation system, which is deemed as the most advanced of the previous generation systems, performs limited management of traditional content repositories only. To this end, the present invention, however, offers a new generation of management systems and processes where such centralized action or management action is equally effectively performed on non-traditional and traditional content repositories. In other words, the present invention allows, among other advantages, search queries and action commands to be implemented on non-traditional and traditional content repositories that are located on a client device.

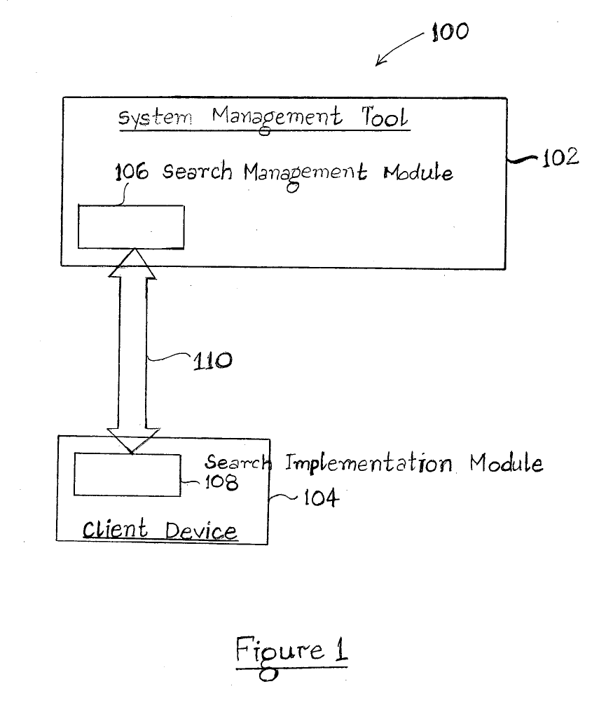

FIG. 1 shows one embodiment of an inventive subassembly 100 that is capable of managing at least one non-traditional content repository. Subassembly 100 includes a system management tool 102 and a client device 104, which includes a non-traditional content repository. A system management module 106 located on system management tool 102 is communicatively coupled to a search implementation module 108 that is located on client device 104. System management module 106 is capable of initiating a search query. By way of example, the search query may be a request seeking certain kind of documents. In this embodiment, modules 106 and 108 are communicatively coupled such that a search query is communicated from module 106 to module 108, and in response to the search query, module 108 can communicate back the result to module 106. Modules 106 and 108 may be communicatively coupled via a connection 110, which can be established by any way that is well known to those skilled in the art. By way of example, connection 110 includes network protocols including TCP/IP, UDP/IP, SNA, IPX/SPX, NetBIOS using a variety of mechanisms including message queuing, SOAP, web services, direct protocol connections like TCP/IP Sockets using a number of physical connection systems including physical wires, wireless, infrared, etc.

During a typical management operation on subassembly 100, search management module 106 initiates a search query that is conveyed via connection 110 to module 106, which implements the search query on client device 104 and obtains results responsive to the search query. Using the same connection 110, module 106 conveys the search result to module 108 for further processing. By way of example, a search query that is seeking documents on a client device that are responsive to a particular request for production of documents propounded during a discovery phase in litigation are provided at module 106. From module 106, the discovery request is conveyed to client device 104, where it is implemented. As a result, a list of documents responsive to the implemented discovery request on client device 104 are conveyed from module 108 to module 106. Those skilled in the art will recognize that a plurality of such client devices can be managed by a single search management module 106 and in such embodiments, document lists obtained from each such client device is sent back to search management module 106, which performs further processing. Module 106, for example, may deduplicate the list of responsive documents and report a paired down list of the responsive documents.

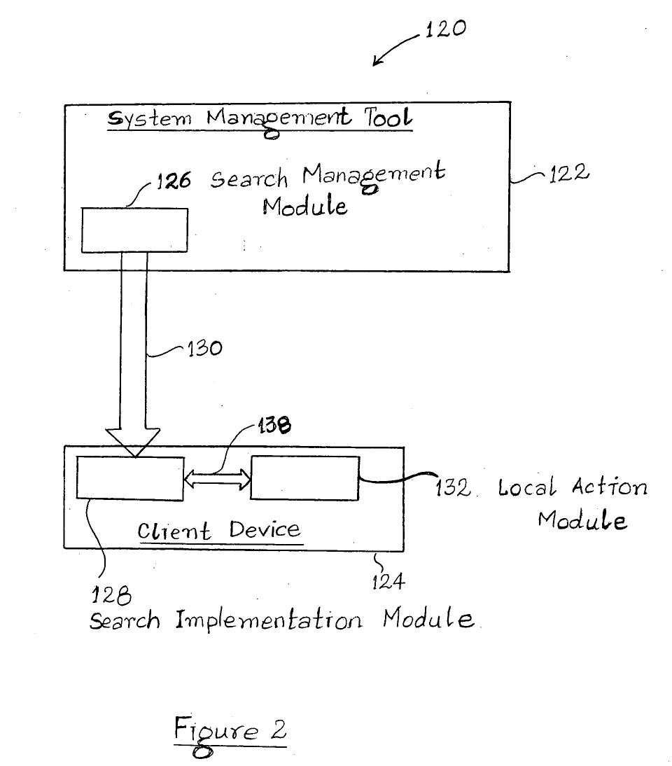

In accordance with another embodiment of the present invention, FIG. 2 shows a management subassembly 120 for managing and taking action on at least one non-traditional content repository. Subassembly 120 includes a system management tool 122 and a client device 124. In this embodiment, client device 124 includes a search implementation module 128 and a local action module 132. System management tool 122 includes a system management module 126 that is communicatively coupled with search implementation module 128 of client device 124 via a connection 130. Connection 130 facilitates flow of information or input signals between modules 126 and 128 in either direction. Further, modules 128 and 132 are communicatively coupled via a connection 138. Connections 130 and 138 may represent the same or different types of connection between the coupled modules.

During a typical operation on subassembly 120 of FIG. 2, system management module 126 initiates a search query similar to that initiated by system management module 106 of FIG. 1. Connection 130 conveys the search query from search management module 126 to search implementation module 128, which implements the search query on client device 124. Connection 138 conveys results that are obtained by implementing the search query to local action module 132 on client device 124 for carrying out a local action on client device 124. Accordingly, in FIG. 2, the requisite action to be taken on the results obtained from the search implementation module is carried out by local action module 132, as opposed to a module located on system management tool 122. By way of example, local action module 132 is capable of sending a notification to a user, lock access to the client device, move a file, copy a file, transform the file format, download a code module, execute or initiate a custom search module, deduplicate files; expunge files; quarantine files, initiate a process, pause a process, stop a process, modify a file, encrypt a file, decrypt a file, compress a file, decompress a file, audit activity of a file, upload a file, download a file, create digital signature of a file, change file permissions, update user information, interact with an external service and destroy files.

FIG. 2 can be implemented in many different ways. By way of example, an automated cleanup service can be organized using the configuration shown in FIG. 2 to clean up information on a user's desktop or laptop computer. In many legal cases companies have lost millions of dollars in damages due to information that should not have been on the user's workstation. In one case the damaging file was in the user's recycle bin and in another case the file was recently deleted but still recoverable. In the service organized according to FIG. 2 of the present invention, a user creates a regularly scheduled job in the system management tool in a first step and in a next step, the search job is transferred to various client devices. On a periodic basis the search job is executed and the results of the search are passed to a local action module on the client device. The local action module then takes an action like deleting the files from the client device, for example.

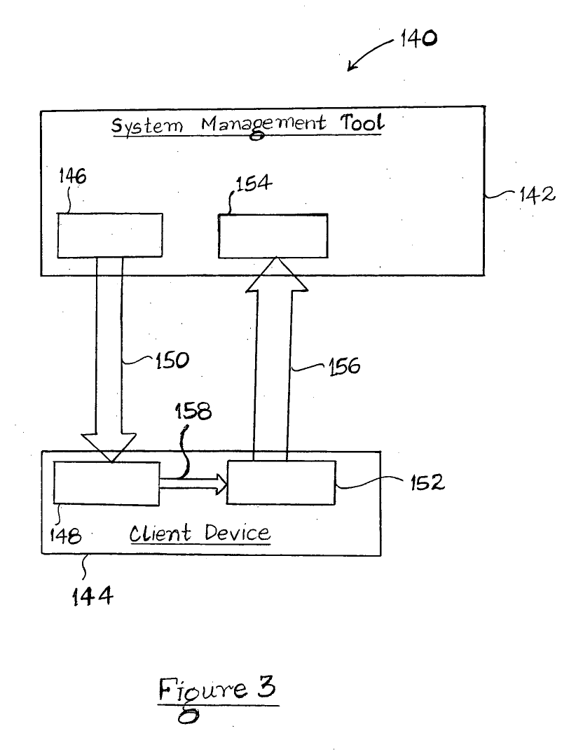

It is also possible that an inventive subassembly according to the present action not use the client device's local action module to take all the necessary action on the client device as explained above in connection with FIG. 2. Rather, based on the results obtained from a search implemented by the search implementation module located on the client device, certain management actions or further action can be taken by an action management module located on an inventive embodiment of the system management tool. An action management module allows effective centralized action to be taken over all traditional and/or non-traditional content repositories. To this end, FIG. 3 shows a subassembly 140, which includes an inventive system management tool 142 that comes equipped with an action management module 154 for taking the appropriate management action or further action on the results of search implemented on client device 152. In the embodiment of FIG. 3, other components, such as the search management module, the search implementation module, the connection between the search management module and the search implementation module, the local action module are configured substantially similarly as shown in the embodiment of FIG. 2. For this reason, these components of FIG. 3 operate in substantially similar fashion as their counterparts of FIG. 2 during a typical operation.

Except that in FIG. 3, a connection 156 is provided between local action module 152 and action management module 154 for communicatively coupling the two modules to each other, such that action management module 154 is capable of receiving an input from client device 144 and based on this input, module 154 is also capable of taking the appropriate action. In one embodiment of the present invention, module 154 takes further action on client device 144 after some initial action on client device 144 has already been taken by local action module 152. By way of example, in the context of responding to request for documents pursuant to legal discovery conducted during litigation, local action module 152 performs the initial action of uploading responsive files to a content repository and action management module 154 performs the subsequent action of registering the files as records and placing them on a legal hold.

The configuration shown in FIG. 3 can be implemented to search for and remove information that is stored on a user's desktop that contains inappropriate language and then notify the user or their management that the offending information was found and deleted. The first step in this process is to create a search query in a system management tool. This search query is then transferred from the system management tool to a search implementation module on a client device, which in response executes a word and/or a phrase search on the client device. In the event that any search results responsive to the search terms are found, the search results are transferred to the local action module. Once this transfer process is complete, the local action module takes the action that was defined in the search job. This action could be to delete the resulting search results. Once the action has been completed, the local action module would communicate its actions to the action management module in the system management tool. In response, the action management module might then take the action of sending an email to the user whose workstation just had the offending search results deleted from it and an email to that user's manager informing the manger of the user's violation of corporate policy regarding the offending information.

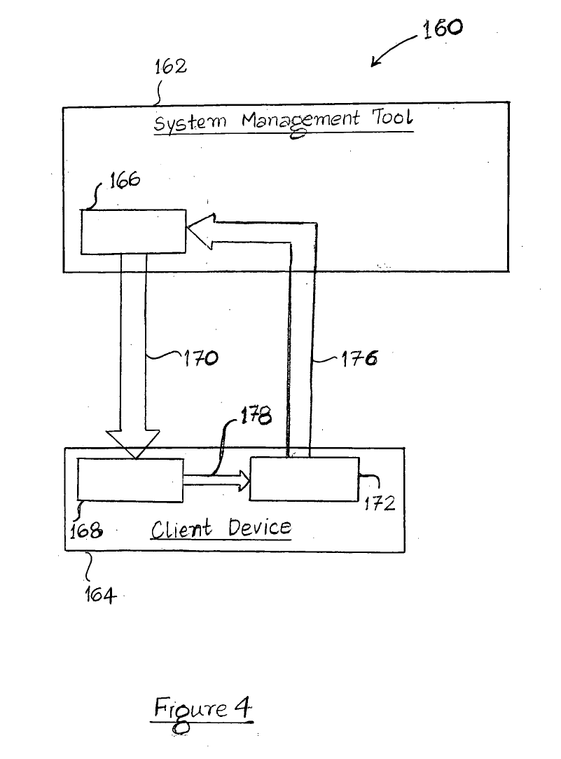

In certain applications, it is desirable that after the local action module takes action on the client device, it reports to the system management tool so that the results obtained from the client device are appropriately processed. To this end, subassembly 160 of FIG. 4 provides an alternative inventive embodiment which provides a connection 176 for communicatively coupling a local action module 172 located on client device 164 with a search management module 166 on system management tool 162. During a typical operation on subassembly 160, such a connection allows local action module 172 to report or provide an input to search management module 162 for further processing. By way of example, local action module 172 can take an action on client device 164 and then reports to search management module 166 that the appropriate action has been taken on client device 172. Search management tool 162, or specifically search management module 166, processes the results so that the user of the system management module may have a view of the responsive files and then execute further refinements of the search to reach a final set of files that are deemed responsive to a particular legal or audit hold.

By way of example, the embodiment of FIG. 4 can be implemented to execute searches based on custom code modules of a user's workstation from a central location. This type of inventive system is useful for searching for non-textual information which might be embedded in image information or is proprietary information format. The first step in this process is to create a search in the system management tool and then to transmit the search to a search implementation module located on a client device. The next step would be for the search implementation module to generate a list of files meeting the search criteria. This list of files would then be transmitted to the local action module. The local action module would then download a custom code module which is then executed against the list of files from the search implementation module. The results generated by the local action module is then transmitted to the search management module in the system management tool for further processing, e.g., deduplication or filtering of search results.

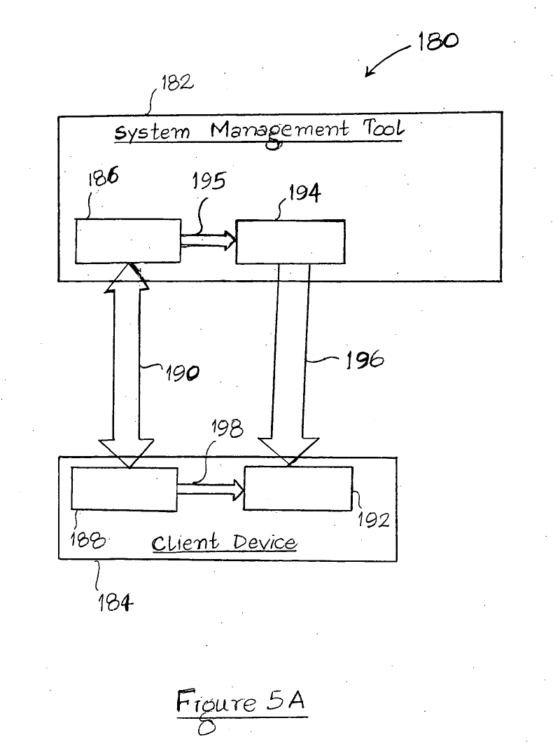

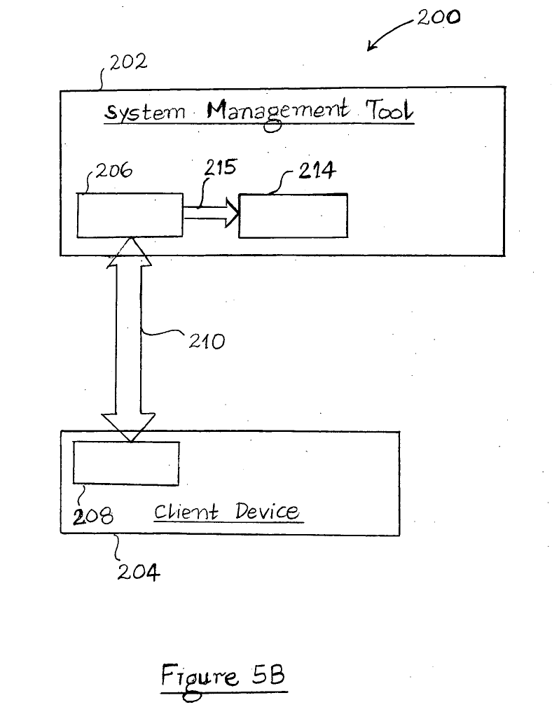

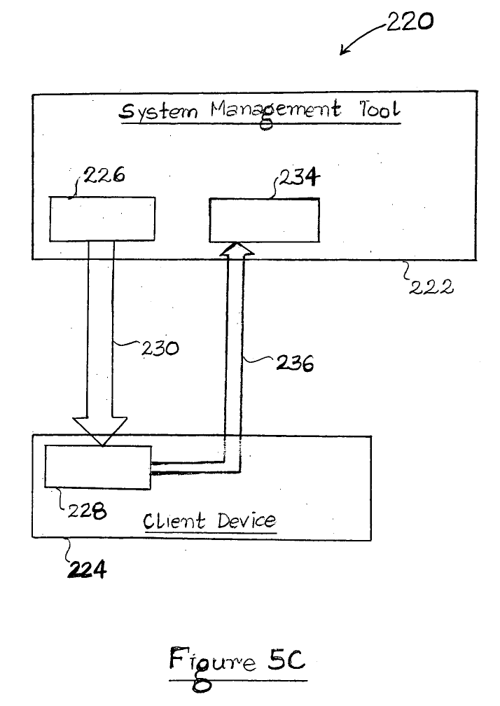

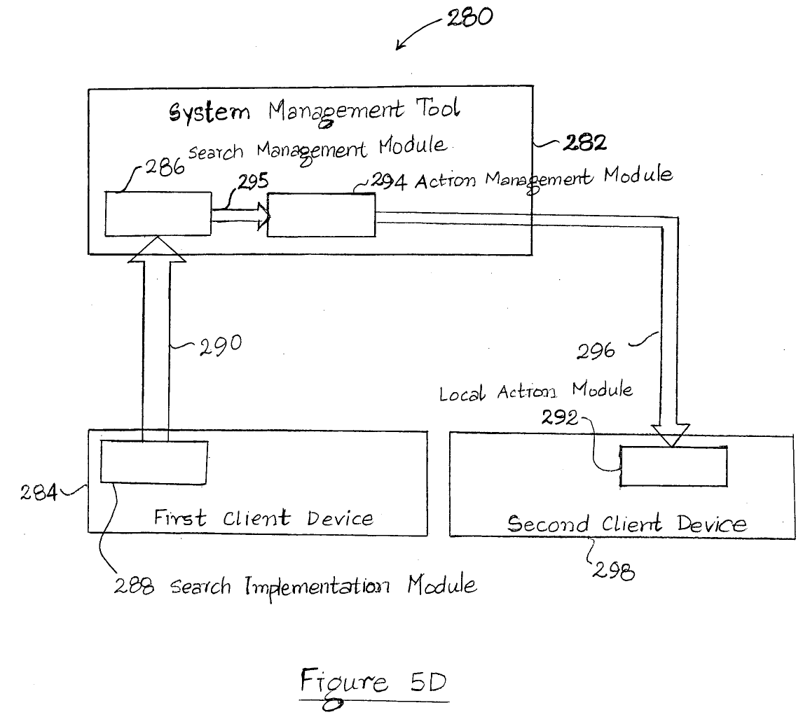

FIG. 5A shows a yet another inventive embodiment of a subassembly 180, which effectively manages and takes action on non-traditional content repositories. In this embodiment of the present invention, action on the client device is taken by management decisions made by the system management tool and taken by certain decisions made by the search implementation module located on the client device. Recall that the embodiment of FIG. 3 need not operate in this manner. In the embodiment of FIG. 3, local action management module 152 preferably takes initial action on client device 144 and action management module 154 takes further action based on an input from module 152, without relying on input from search management module 146. In the embodiment of FIG. 5A, however, the action management module need not wait to receive an input from the local action module located on the client device.

Rather, in the embodiment of FIG. 5A, action management module 194 is configured to also receive an input from search management module 186, and in response, instructs local action module 192 to take the appropriate action on client device 184. A connection 195 between search management module 186 and action management module 194 communicatively couples the modules for conveying the necessary input between the two modules in either direction. On the client device side, a similar connection 198 between search implementation module 188 and local action module 192 allows for another input to be conveyed between the modules in either direction. The input from module 186 may impact the action taken by action management module 194, which in turn impacts the action taken by local action module 192 on client device 184.

During a typical operation cycle in the embodiment of FIG. 5A, therefore, action can be taken on client device 184 according system management rules, which are set at the system management tool level, and also by local management rules, which are set at the client device level. Therefore, the embodiment of FIG. 5A provides a great deal of flexibility in managing client devices.

By way of example, a tool can be constructed to provide a centralized legal discovery service for companies according to one embodiment of the present invention. This discovery tool can search all or part of a company's laptops or desktops for documents and/or emails that meet a particular set of search criteria and then take action on the results of that search like transferring the resulting files to a central document repository; registering it as a records and placing the files on a legal hold. Additionally and extremely important in order to ensure that a search is thorough and defensible in court or in front of a regulatory body, the transferring of the search query can be queued pending a user attaching their laptop to the corporate network. A user creates a search query in the search management module, from where the search query is transmitted to various client devices, which are being managed by the system management tool. The client devices in this embodiment include those that are disconnected from the system management tool and are not connected to the communication infrastructure at the time of the transmission. Additionally the search management module will send a list of expected client devices to the action management module so that the searching user can identify what machines were missed during the search. The search implementation module executes a search on the client device and the results of the search are processed in the local action module. This processing might include sending a copy of the file to a central repository for further handling and/or quarantining the information locally on the client device such that a user of the client device is unable to delete or modify the information. The results of the local actions are transferred to the action management module. The action management module then would log the results of the search for each of the client devices and then any information that was transmitted from the client device could then be stored in a document repository, registered as a record and then placed on a legal hold.

As another example of implementing FIG. 5A, a tool can be created to help support NASD 3010 and SEC supervisory requirements of brokerage houses. Presently, these companies are required to review the documents, emails and instant messages that are sent out to customers. Current solutions only address emails and instant messages that are processed through central corporate servers. This works relatively well for brokers that are direct employees of a brokerage firm, but many brokerage houses and insurance firms have a different model that use an independent broker who might provide services to multiple brokerage houses. At the present time violations are only detected after they are sent to the customer, but if a firm were to regularly scan the contents of a broker's computer, they could detect information that is in violation prior to it being sent to the customer.

Moreover, to further address the independent broker issue, this tool can review the contents of information stored in the independent broker's laptop or desktop and still allow the broker to use their own systems and processes independent of various brokerage firms. The first step would be for the brokerage firm's compliance officer to create a search for the offending material. In general these searches are predefined by a team of lawyers to address the various scams that brokers try to use. This search is then transmitted to the search implementation module located on a broker's laptop, which is the client device. Additionally, a list of computers that are being searched will be transmitted to the action management module. The search implementation module then executes the search and passes these results to the local action module. The local action module takes the predefined action; usually this action will be to quarantine the file and then transmit the violation to the action management module which might then notify the broker's manager and/or compliance officer and place a copy of the file in a central repository.

Certain designs of the invention subassemblies of the present invention allow for certain actions are to be taken in response to results obtained from implementing the search query on one or more client device. To this end, using client device 204, as an exemplar, FIG. 5B provides an inventive subassembly 200 in accordance with one embodiment of the present invention. In this embodiment, a system management tool 202 includes a search management module 206 and an action management module 214, which are communicatively coupled via a connection 215 such that an input can be conveyed from module 206 to module 214. A client device 204, which is managed by system management tool 202, includes a search implementation module 208. A connection 210 between search management module 206 and search implementation module 208 allows for a search query to be conveyed from module 206 to module 208 and the results from module 208 back to module 206.

During a typical operation cycle on subassembly 200 of FIG. 5B, search management module initiates a search query which is conveyed via connection 210 to search implementation module 208 for implementing the search query on client device 204. Results obtained from implementing the search query on client device 204 are conveyed to search management module 206, which processes the results. Module 206 usually based upon such results provides an input to action management module 214, which input prompts module 214 to take action. In the embodiment of FIG. 5B, the action is typically one that informs the provider of the search query (e.g., an auditor) or the manager of the client devices of the results obtained from the client devices. By way of example, upon receiving results associated with a certain client device from a search implementation module, the search management module processes the results, e.g., de-duplicates files, and then provides an input to action management module, which sends an email reporting the results to a manager of the client devices.

After implementing a search query on a client device, instead of sending the search results obtained from the search implementation module back up to the search management module, it is possible to send an input based on such results directly to an action management module located on the system management tool. FIG. 5C shows a subassembly 220 that is similar to subassembly 200 of FIG. 5B, except that in FIG. 5C results from search implementation module 228 bypass search management module 226 and are sent directly to action management module 234. Action management module 234 is capable of taking similar actions as action management module 214 of FIG. 5B, however, module 234 takes such similar action based on local management rules, and not necessarily based on system management rules as in FIG. 5C.

Those skilled in the art will recognize that although the described embodiments depict a single client device, inventive system management tools of the present invention are capable of easily managing more than one client devices in a manner similar to how a single client device is managed in the described embodiments. The present invention, however, contemplates that during the management of one or more client devices, it is possible that the results of a search query obtained form a first client device may impact the action taken on a second client device. To address this, FIG. 5D shows an inventive subassembly 280 which includes a system management tool 282, a first client device 284 and a second client device 298. To facilitation discussion and illustration, first client device 284 is shown to have a search implementation module 288 and second client device 298 is shown to have a local action module 292. System management tool 282 includes a search management module 286 and an action management module 294. Appropriate connections 290, 295 and 296 are provided to convey information between the modules shown in FIG. 5D.

During a typical operation cycle, search management module initiates a search query which is conveyed via connection 290 to a search implementation module 284 on a first client device 284, where the search query is implemented. The results obtained at module 288 are conveyed back via connection 290 to module 286. In one embodiment of the present invention, based upon the results obtained at module 286, module 286 provides an input to action management module 294, which in turn takes a particular action on second client device 298. As a result, action management module instructs a local action management module 292 residing on second client device 298 to take action on that client device. By way of example, a user modifies the metadata values of a document which are transmitted via the system management tool to the second client device whose local action module then updates the metadata values of the same file which resides on the second client device.

Inventive search management tools of the present invention need not necessarily include a search management module. It is possible for a system management tool to manage one or more client device without assistance from a search management module. To this end, inventive subassembly 240 of the present invention includes an action management module 254 which is communicatively coupled via connection 250 with a local action module 248 located on a client device 244. During a typical operation cycle on subassembly 240, action management module sends instruction commands via connection 250 to local action module 248. In response local action module 248 accordingly performs these instructions on client device 244. By way of example, action management module instructs local action module 248 to expunge all temporary files on a client device on a weekly basis.

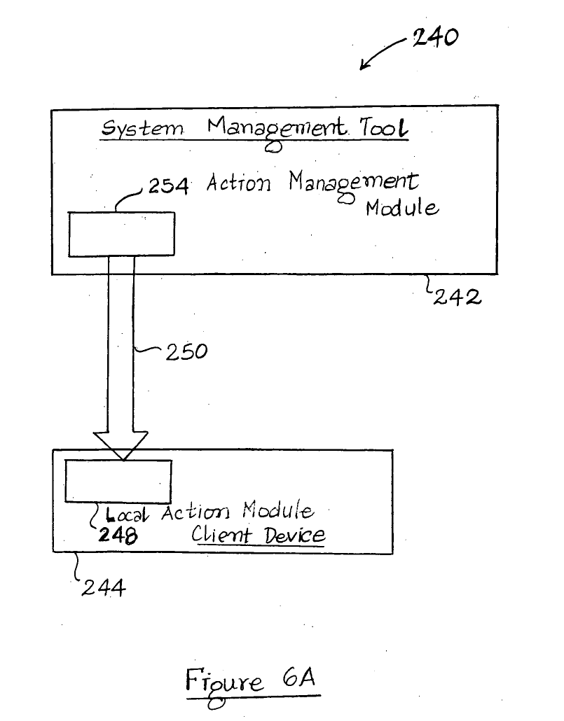

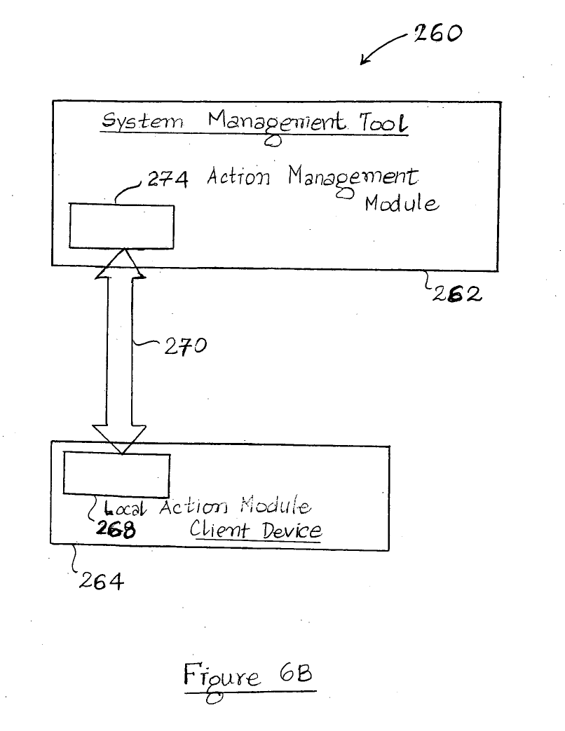

In alternative embodiments of the present invention, after taking action on the client device, the local action module sends an input to the action management module for taking a management action. To this end, FIG. 6B provides a two way connection 270 which allows action management module 274 located on system management tool 262 to send instructions to local action module 268 located on client device 264. After local action module 268 takes action on client device 264, it then send an input via the same connection 270 back to module 274, which in turn performs a management action. By way of example, after local action management module 268 performs a certain action on client device 264, the action management module 274 is informed of it and module 274 sends an email to the user of the system management tool or the user of the particular client device that a particular action has been taken on a particular client device.

The present invention offers various methods for managing client devices, which include non-traditional and/or traditional content repositories and preferably use the system management tools described above. In one preferred embodiment of the present invention, a method begins by initiating a search query in a management tool. By way of example, the search query might be a request for production of documents. A user opens the search interface tool of the system management tool and initiates a search of all the company's laptops for a set of terms related to a lawsuit. The search management module identifies all client devices and queues the query for these client devices. The local search module (also known as the search implementation module) of the client device retrieves the query from the search management tool and executes the search. The results of the search are then transmitted from the local search module to the system management tool. The user might then analyze the results and mark some results as non responsive and might mark the others for subsequent action. This action might be for the action management module to instruct each local action management module to transfer a copy of each unique file to a content repository. Once the item has been properly loaded into the content repository, the file would then be registered as a record and placed on a legal hold in the information lifecycle management tool. Additional action could be taken by the local action module to quarantine the file so that the user could make not further changes to the document on their laptop. This search query might be provided to the management tool either by a user of the management tool or another tool, such as an Enterprise Content Integration tool. The inventive methods of the present invention also include conveying the search query from the management tool to a client device. Another step involves implementing the search query on the client device to obtain responsive search results. These search results are then sent from the client device to the management tool.

In preferred embodiments of the present invention, a management tool manages one or more client devices. In such preferred embodiments, before conveying the search query from the management tool to a client device, it is desirable to perform a step of identifying a particular client device for implementing the search query thereon. By way of example, each client device may be provided with an address and this step may be carried out by identifying the address or addresses to which the search query is sent. Once the target client devices for implementing the search query are identified, then the search query is conveyed to a plurality of client devices. In the event that the client device is not available the query is stored until the client device becomes available or a predetermined period of time has expired. On these plurality of client devices, the search query is implemented and results of the search query are then sent to the management tool. Implementing the search query on a client device provides results, which can be of any form including one or more files.

Each such result obtained at a client device is associated with that client device, such that the results obtained from the different client devices can be tracked to the particular client device they originate from. In preferred embodiments of the present invention, when the management tool receives such results from different client devices, it performs the task of associating a result obtained from a particular client device with that particular client device. This inventive feature allows the management tool to take action on certain workstations, for example, workstations that may be located in the U.S. to comply with U.S. document retention laws.

The search management tools of the present invention ar capable of performing a myriad of processing functions, one of which includes filtering results obtained from the plurality of client devices to produced a filtered result. Specifically, a search management module located on the management tool can be configured to perform such processing functions. Those skilled in the art will, however, recognize that the filtering step may very well be carried out on a client device (e.g., search implementation module) instead of being carried out on a management tool. On the client device, processing functions are preferably carried out before the search results are sent to the management tool. Regardless of where the results are filtered, results are preferably filtered based on a predetermined characteristic of a file, which is any one member selected from a group comprising application file, application support file, log file, configuration file, database file, backup file, archive file, device driver file, multimedia file, data file, document, email, storage media image file, virus, operating system support file and operating system file. Files having at least one of the above-mentioned characteristics, which may be specified by a user, are filtered, so that a user is provided with a succinct list of files.

In alternative preferred embodiments, a process for managing a client device, which includes a non-traditional content repository, is capable of taking action based upon the results obtained from implementing a search query. In such alternative embodiments, the process typically begins with a step of initiating a search query in a management tool. In a next step, the search query is conveyed from the management device to the client device for implementation. After the search query is implemented on the client device to produce a result, a step of taking action is performed on the result of the search query. The step of taking action may be performed at the management level by an action management module (e.g., module 154 of FIG. 3, module 194 of FIG. 5A, module 214 of FIG. 5B, module 234 of FIG. 5C, and module 294 of FIG. 5D) and/or at a local level by a local action module (e.g., module 132 of FIG. 2, module 152 of FIG. 3 and module 172 of FIG. 4, module 192 of FIG. 5A, and module 292 of FIG. 5D).

In certain embodiments of the managing process according to the present invention, the step of implementing is performed by a search implementation module located on the client device and the step of taking action is performed by an action management module also located on the management tool, such as that shown in FIG. 3.

Those skilled in the art will recognize that-on many occasions, connection between a client device and a management tool may be synchronous or asynchronous. In a synchronous connection, communication between the management tool and each of the different client devices that it manages is carried out at the same time or in a synchronous manner. However, in certain circumstances, one or more client devices may not be connected to a management tool when the management tool is ready to initiate a search query, making it a asynchronous connection. In embodiments where the connection between the management tool and client device is asynchronous, before the search query is conveyed from the management tool to the client device, a step of establishing a communication connection between the management tool and the client device should be performed. By way of example, this step may include generating a signal requesting connection from the client device to the management tool or alternatively, include generating a signal requesting connection from the management tool to the client device.

To provide for asynchronous connection where a management tool and a client device are not communicatively coupled to transfer the results from the client device to the management tool, the inventive managing process includes storing temporarily on the client device, preferably storing on the search implementation module on the client device, results of the search query. In these embodiments, sending includes sending temporarily result of the search query to the management tool when communication is established between the client device and the management tool.

In some preferred embodiments of the present invention, a management tool may carry out certain tasks of periodically cleaning out certain types of files from a client device. In such embodiments, the step of initiating a search query includes using a job scheduler, which automatically dispatches the search query according a predetermined rule stored in the job scheduler. By way of example, a job is scheduled to run on all client devices to find and destroy all documents that contain words that are considered inappropriate to the corporation.

In certain preferred embodiments, the inventive managing process provides for performing both local and management actions on the results obtained on a client device. By way of example, subassembly 140 shown in FIG. 3 is used for carrying out such inventive managing processes. In these embodiments, the process includes a step of providing the result from a search implementation module (e.g., module 148 of FIG. 3) to a local action module (e.g., module 152 of FIG. 3) for taking local action on the results. Then for taking management action, the inventive processes includes a step of sending input from the local action module (e.g., module 152 of FIG. 3) to the action management module (e.g., module 154 of FIG. 3) for taking management action on the input. By way of example, such inventive processes provide initial filtering of files as a local management action and deduplication as a subsequent management action.

In other preferred embodiments of the inventive managing processes is carried out using subassembly 200 of FIG. 5B, for example. In such embodiments, the initiating step is carried out by a search management module (e.g., module 206 of FIG. 5B) on the management tool, the implementing step is performed by a search implementation module (e.g., module 208 of FIG. 5B) on the client device. These inventive methods further include a step of providing a result from the search implementation module (e.g., module 208 of FIG. 5B) on to the search management module (e.g., module 206 of FIG. 5B) and a step of sending an input from the search management module (e.g., module 206 of FIG. 5B) to the action management module (e.g., module 214 of FIG. 5B) for taking management actions based on the input received at the action management module.

In alternative preferred embodiments of the inventive managing processes, action is taking on a local level or at the client device level using, for example, subassembly 220 of FIG. 5C. Such alternative embodiments include providing result from the search implementation module (e.g., module 228 of FIG. 5C) on the client device to an action management module (e.g., module 234 of FIG. 5C) located on the management tool. This providing steps allows the action management module (e.g., module 234 of FIG. 5C) to perform the step of taking action based on the input received at the action management module.

In alternative embodiments, an action management module (e.g., module 194 of FIG. 5A and module 294 of FIG. 5D) is configured to provide the appropriate commands for the required actions which are carried out by another module (e.g., module 192 of FIG. 5A and module 292 of FIG. 5D). In such alternative embodiments, It is possible that the command of the action management module is based on input received by the action management module from the search management module.

Regardless of whether the local action module on the client device takes action according to rules set at the local level or receives command from the action management module at the management level, certain inventive managing processes after taking local action by a local action management module, provide the flexibility of further processing at the management level. In this context, after the result from the search implementation module on the client device is provided to the local action module, the local action module takes action and sends an input to the search management module located on the management tool, which in response performs further processing, e.g., deduplication. The configuration of subassembly 160 shown in FIG. 4 is preferably employed to perform such processing after taking local action. Local action in the present invention includes any action taking at a local level by a client device. By way of example, such action includes any one action selected from a group consisting of sending a notification to a user, locking access to the client device, moving a file, copying a file, transforming the file format, downloading a code module, executing or initiating a custom search module, deduplicating files; expunging files; quarantining files, initiating a process, pausing a process, stopping a process, modifying a file, encrypting a file, decrypting a file, compressing a file, decompressing a file, auditing activity of a file, uploading of file, downloading of file, creating digital signature of a file, changing file permissions, updating user information, interacting with an external service and destroying files.

The inventive processes described above are not limited to employing a search management module and/or a search implementation module. The present invention provides processes for managing a client device using action based modules and without relying upon search based modules. These embodiments of the inventive processes include a step of initiating an action command in an action management module located on a management tool which is designed to manage the client device. Next, a step of conveying is carried out such that the action command from the management tool to is conveyed to the client device. In response to the command, an action is performed. In certain embodiments, the action is carried out using a local action module. In alternative embodiments, the embodiment described further includes a step of sending an input from the local action module to the action management module after taking local action on the client device and then a step of taking management action using the action management module.

Although the present invention has been described in considerable detail with reference to certain preferred versions thereof, other versions are possible. Therefore, the spirit and scope of the appended claims should not be limited to the description of the preferred versions contained herein.

What is claimed is:

1. A system management tool comprising a search management module which is capable of initiating a search query and is designed to be communicatively coupled with a client device such that when said search management module is communicatively coupled to said client device, said search query initiated at said search management module is communicated to said client device to search a non-traditional content repository.

2. The system management tool of claim 1, further comprising an action management module that is designed to be communicatively coupled with said client device such that when said action management module is communicatively coupled to said client device, said action management module is capable of receiving an input from said client device and said action management module is capable of taking action on said input.

3. The system management tool of claim 2, wherein said action management module is also capable of sending an action command to a local action module located on said client device that is designed to implement said action command.

4. The system management tool of claim 1, wherein said search management module is capable of receiving an input from said client device in response to said search query initiated by search management module and said search management module is designed to process said input.

5. The system management tool of claim 4, further comprising an action command module wherein said search management module provides an input to said action command module to take action.

6. A system management tool comprising an action management module that is capable of initiating an action command and is designed to be communicatively coupled with a client device, such that when said action management module is communicatively coupled to said client device, said action command initiated at said action management module is communicated from said action management module to said client device and implemented upon a non-traditional content repository.

7. The system management tool of claim 6, wherein when said action management module is communicatively coupled to a local action module located on said client device, said local action module at least partially implements the action directed by said action command from said action management module.

8. The system management tool of claim 7, wherein said action management module is designed to receive an input from said local action module and based upon said input, said action management module takes further action.

9. A client device comprising a search implementation module capable of implementing on said client device a search query that is generated by a system management tool and wherein after implementing the search query, said search implementation module is configured to obtain a result from a non-traditional content repository on said client device.

10. The client device of claim 9, wherein said search implementation module is capable of reporting said result to said system management tool.

11. The client device of claim 9, further comprising a local action module capable of taking action on said client device, and wherein said search implementation module is configured to report said result to said local action module that is designed to take action on said client device.

12. The client device of claim 9, further comprising a local action module capable of taking action on said client device, and said search implementation module is configured to report said result to said local action module that is designed to take action on said client device and also designed to send an input to an action management module located on said system management tool for taking further action.

13. The client device of claim 9, further comprising a local action module capable of taking action on said client device, and said search implementation module is configured to report said result to said local action module that is designed to take action on said client device and also designed to send an input to said search management module.

14. The client device of claim 10, further comprising a local action module capable of taking action on said client device, wherein said search management module is configured to send an input to an action management module on said system management tool and said local action module is configured to take action based on action command received from said action management module.

15. The client device of claim 9, wherein said search implementation module is capable of sending an input to a action management module for taking action.

16. A client device comprising a local action module designed to take action on said client device based on an action command received from an action management module located on a system management tool, wherein said client device is a non-traditional content repository.

17. The client device of claim 16, wherein said local action module is designed to send an input to said action management module for taking further action.

18. A system management tool comprising an action management module designed to send an action command to a local action module located on a client device that is a non-traditional repository.

19. A system management tool comprising:
a search management module communicatively coupled to a first client device and an action management module located on said system management tool, such that said search management module is designed to send an input to said action management module based upon a result received from said first client device;
an action management module communicatively coupled to a second client device and said action management module is designed to provide an action command to said second client device based upon said input; and
wherein said first client device and said second client device are non-traditional content repository.

20. A first client device configured to provide an input to a system management tool that is communicatively coupled to a second client device, and said client devices are capable of searching non-traditional content repositories.

21. A first client device configured to provide an input to a system management tool that is communicatively coupled to a second client device, and said client devices are capable of taking action on non-traditional content repositories.
